(19) United States
(12) Patent Application Publication
(10) Pub. No.: US 2025/0058474 A1
(43) Pub. Date: Feb. 20, 2025

(54) ROBOT CONTROL DEVICE

(71) Applicant: FANUC CORPORATION, Yamanashi (JP)

(72) Inventor: Yuta NAMIKI, Yamanashi (JP)

(73) Assignee: FANUC CORPORATION, Yamanashi (JP)

(21) Appl. No.: 18/724,984

(22) PCT Filed: Mar. 2, 2022
(86) PCT No.: PCT/JP2022/008775

§ 371 Date: Jun. 27, 2024

(51) Int. Cl. B25J 9/16

(52) U.S. Cl. CPC B25J 9/1697

(57) ABSTRACT

Provided is a robot control device that can easily switch between an external image processing device and a built-in image processing device. In this robot control device, which uses an image processing device to image a target object by means of a vision sensor mounted on a robot or to image the target object by means of the vision sensor fixed and installed at a prescribed position, the image processing device is embedded in the robot control device or externally connected to the robot control device, and a vision execution command in a vision program in the image processing device and a vision execution command in a robot program in the robot control device are substantially shared by a built-in image processing device built into the robot control device and an external image processing device externally connected to the robot control device.

### TECHNICAL FIELD

The present invention relates to a robot control device.

### BACKGROUND ART

There has been known a system that detects or inspects a workpiece by a vision sensor attached to a robot and causes the robot to perform a work on the workpiece (see, e.g., Patent Document 1).

In such a system, an image processing device is connected to a robot control device, an image processing result is acquired from the image processing device, and the robot control device performs a work using the acquired result. Further, there has also been known a configuration in which the image processing device is built into the robot control device. In this configuration, an external image processing device is not necessary, and a vision function can be used at a low cost.

### CITATION LIST

### Patent Document

Patent Document 1: Japanese Unexamined Patent Application, Publication No. 2018-195107

### DISCLOSURE OF THE INVENTION

### Problems to be Solved by the Invention

Although the image processing device built into the robot control device reduces cost, an image processing capability is limited by a computing capability of the robot control device. On the other hand, although the image processing device provided externally to the robot control device increases cost, the image processing capability is not limited by the computing capability of the robot control device. Both these devices need to be separately used according to an image processing capability required for an application.

That is, when the image processing capability is required, the built-in image processing device needs to be easily switched to the external image processing device, and conversely, the external image processing device needs to be easily switched to the built-in image processing device. For this reason, there has been demanded a robot control device capable of easily switching between an external image processing device and a built-in image processing device.

### Means for Solving the Problems

A robot control device according to one aspect of the present disclosure includes at least one image processing device that images a target by a vision sensor mounted on a robot or fixed and installed at a predetermined position. The at least one image processing device is built into the robot control device or is externally connected to the robot control device, and a vision execution command in a vision program in the image processing device and a vision execution command in a robot program in the robot control device are substantially common between a built-in image processing device built into the robot control device and an external image processing device externally connected to the robot control device.

A program generation device for generating a program related to a robot according to one aspect of the present disclosure includes a receiving unit that receives selection of a built-in image processing device built into a robot control device or an external image processing device provided externally to the robot control device, and a generation unit that, in a case in which at least one of the built-in image processing device or the external image processing device is selected, makes a vision execution command in the program substantially common therebetween.

A robot control device connectable to at least one image processing device according to one aspect of the present disclosure includes a first connection unit connectable to the at least one image processing device, and a second connection unit, which is different from the first connection unit, connectable to the image processing device. A vision execution command in a vision program in the at least one image processing device and a vision execution command in a robot program are substantially common in a case where the image processing device is connected to at least one of the first connection unit or the second connection unit.

A robot control device connectable to at least one image processing device according to one aspect of the present disclosure includes a connection unit connectable to the at least one image processing device. A vision execution command in a vision program in the at least one image processing device and a vision execution command in a robot program are substantially common regardless of whether or not the at least one image processing device is connected to the connection unit.

### Effects of the Invention

According to the present invention, it is possible to provide the robot control device capable of easily switching between the external image processing device and the built-in image processing device.

### BRIEF DESCRIPTION OF THE DRAWINGS

FIG. 1 is a diagram showing the configuration of a robot system according to the present embodiment;

FIG. 2 is a diagram showing a functional configuration of a robot control device;

FIG. 3 shows an example of a robot program in the case of using a built-in image processing device; and

FIG. 4 shows an example of the robot program in the case of using an external image processing device.

### PREFERRED MODE FOR CARRYING OUT THE INVENTION

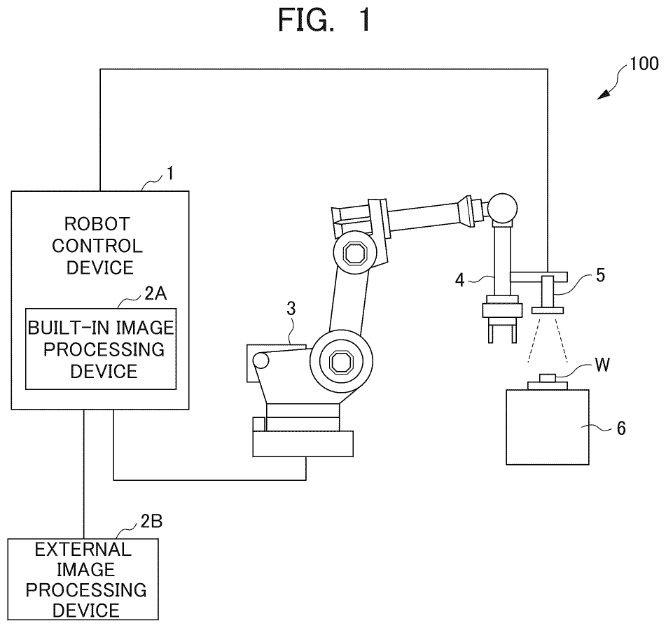

Hereinafter, one exemplary embodiment of the present invention will be described. FIG. 1 is a diagram showing the configuration of a robot system 100 according to the present embodiment. As shown in FIG. 1, the robot system 100 includes a robot control device 1, an image processing device 2A, an image processing device 2B, a robot 3, an arm 4, and a vision sensor 5.

The robot control device 1 executes a robot program for the robot 3 to control operation of the robot 3. The robot control device 1 uses the image processing device 2A, 2B that images a target W by the vision sensor 5 mounted on the robot 3. Alternatively, the robot control device 1 may use the image processing device 2A, 2B that images the target W by the vision sensor 5 fixed and installed at a predetermined position.

The image processing device 2A is a built-in image processing device built into the robot control device 1, and the image processing device 2B is an external image processing device externally connected to the robot control device 1. The image processing device 2A, 2B controls the vision sensor 5, and processes the image captured by the vision sensor 5. The vision sensor 5 is connectable to any of the image processing devices 2A, 2B. The image processing device 2A, 2B uses the processed image for control of the robot 3 by the robot control device 1. The image processing device 2B may be communicable with a cloud computer via a network.

The image processing device 2A, 2B holds a model pattern of the target W, and can execute image processing of detecting a workpiece by pattern matching between the captured image of the target W and the model pattern.

Note that in FIG. 1, both the image processing devices 2A, 2B are connected to the robot control device 1, but one of the image processing devices 2A, 2B may be connected to the robot control device 1. The robot system 100 may have two or more image processing devices 2A and two or more image processing devices 2B.

The robot 3 is, for example, an articulated robot, and a hand or a tool is attached to a tip end portion of the arm 4 of the robot 3. Under the control of the robot control device 1, the robot 3 performs a work such as handling or machining of the target W on a mount 6. Further, the vision sensor 5 is attached to the tip end portion of the arm 4 of the robot 3.

Note that the robot 3 is not particularly limited to the above-described type and may be other types of robots. The vision sensor 5 is not necessarily attached to the robot 3, and for example, may be fixed and installed at a predetermined position.

The vision sensor 5 images the target W under the control of the image processing device 2A, 2B. The vision sensor 5 may be a camera that captures a grayscale image or a color image, or may be, e.g., a stereo camera or a three-dimensional sensor capable of acquiring a range image or a three-dimensional point cloud. In the present embodiment, the vision sensor 5 may have already been calibrated, and the image processing device 2A, 2B may save calibration data defining, e.g., a relative positional relationship between the vision sensor 5 and the robot 30 and an internal parameter for the vision sensor 5. With this configuration, a position on the image captured by the vision sensor 5 can be converted into a position on a coordinate system (e.g., robot coordinate system) fixed to a workspace. The robot control device 1 processes the image captured by the vision sensor 5 by the image processing device 2A, 2B, and operates the robot 3 using the processed image.

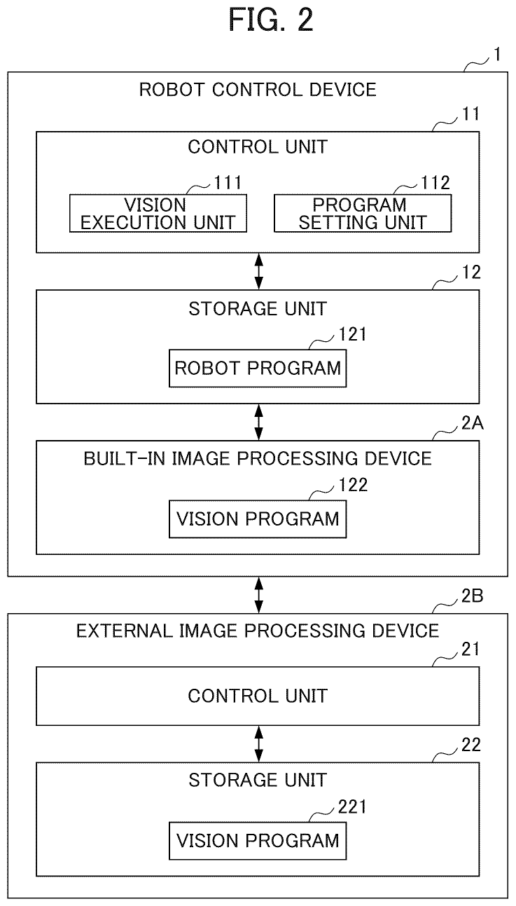

FIG. 2 is a diagram showing a functional configuration of the robot control device 1. The robot control device 1 includes a control unit 11, a storage unit 12, and the image processing devices 2A, 2B. The control unit 11 is a processor such as a central processing unit (CPU), and implements various functions by executing programs stored in the storage unit 12. The control unit 11 includes a vision execution unit 111 and a program setting unit 112.

The vision execution unit 111 executes a vision execution command from the robot program, thereby imaging the target W by the vision sensor 5. The vision execution unit 111 detects or determines the target W from the captured image.

The program setting unit 112 sets a command such as the vision execution command in the robot program.

The storage unit 12 is a storage device such as a read only memory (ROM) that stores, e.g., an operating system (OS) or an application program, a random access memory (RAM), or a hard disk drive or a solid state drive (SSD) that stores various other types of information. The storage unit 12 stores, for example, various types of information such as a robot program 121.

The robot program 121 is a program stored in the storage unit 12 and describing operation of the robot 3 and input/output (IO) processing contents. The robot program 121 is, for example, for calling a vision program 122, 222 and acquiring a result.

The vision program 122 is stored in a storage unit of the image processing device 2A, and the vision program 222 is stored in a storage unit 22 of the image processing device 2B. The vision program 122, 222 is a program describing processing contents related to a vision. The vision program 122, 222 is a program created by a user.

In the robot control device 1 according to the present embodiment, the vision execution commands in the vision program 122 in the image processing device 2A and the vision program 222 in the image processing device 2B and the vision execution command in the robot program 121 in the robot control device 1 are substantially common between the built-in image processing device 2A built into the robot control device 1 and the external image processing device 2B externally connected to the robot control device 1. Note that in the present specification, the “substantially common vision execution command” means that the vision execution command is substantially the same and may be partially different. The built-in image processing device 2A is not limited to a case where the image processing device 2A is built into the robot control device 1 as hardware. The built-in image processing device 2A also includes a case where software for implementing the function of the vision sensor is installed in the robot control device 1 and the function of the built-in image processing device 2A is included as part of the function of the robot control device 1.

With this configuration, the vision execution command in the vision program is substantially common between the built-in image processing device 2A and the external image processing device 2B, and therefore, the robot control device 1 can easily switch between the built-in image processing device 2A and the external image processing device 2B. Moreover, since the common vision execution command is applied, the robot control device 1 can use the vision program regardless of the presence or absence of setting by the program setting unit 112.

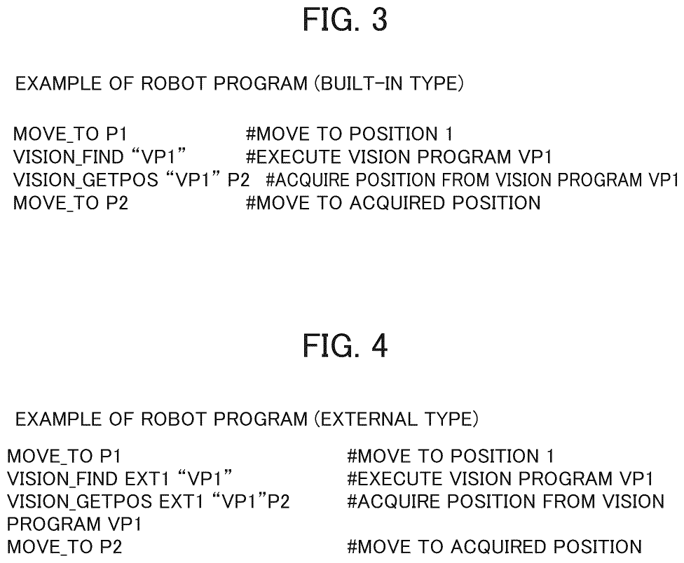

FIG. 3 shows an example of the robot program in the case of using the built-in image processing device 2A, and FIG. 4 shows an example of the robot program in the case of using the external image processing device 2B. As shown in FIG. 4, as compared to the robot program for the built-in image processing device 2A as shown in FIG. 3, an identifier “EXT1” is added to the vision execution command in the robot program for the external image processing device 2B.

Specifically, “VISION_FIND EXT1“VP1”” and “VISION GETPOS EXT1“VP1”P2” in the robot program shown in FIG. 4 are vision execution commands to which the identifier “EXT1” is added.

Here, the vision execution command (VISION FIND) is a command for executing a vision program VP1, and for example, the target W is imaged by the vision sensor 5 and is detected or determined from the captured image. The position acquisition command (VISION_GETPOS) is a command for acquiring a position from the vision program VP1.

By adding a command such as “VISION=EXT1” before the vision execution command, it may be set such that for the subsequent vision execution command, the identifier does not need to be individually specified.

The robot control device 1 transmits the image acquired by the built-in image processing device 2A to the external image processing device 2B, and the external image processing device 2B processes the image. With this configuration, for example, in a case where the external image processing device 2B has a higher processing capability than that of the built-in image processing device 2A, the robot control device 1 can perform greater-load image processing by the external image processing device 2B and can efficiently perform the image processing. The robot control device 1 may be configured such that the vision sensor 5 is directly connected to the external image processing device 2B.

Instead of storing the vision program in the external image processing device 2B as described above, the vision program in the external image processing device 2B may be executed on the cloud. Since the vision program is stored on the cloud, for example, the robot control device 1 can update the vision program via a network and the user can apply the updated latest vision program to the robot control device 1. The robot control device 1 may be configured such that an image processing device provided on the cloud directly performs the image processing and a processing result is transmitted to the robot control device 1. With this configuration, an access to the vision program can be made from anywhere, and the image processing software can be easily updated to the latest software.

A setting screen for setting the vision program is substantially common between the built-in image processing device 2A and the external image processing device 2B. For example, the setting screen for setting the vision program, such as a user interface (UI), is substantially common between both the built-in image processing device 2A and the external image processing device 2B. With this configuration, the user of the robot control device 1 can use both the built-in image processing device 2A and the external image processing device 2B by similar operation.

The history of execution of the vision program is substantially common between the built-in image processing device 2A and the external image processing device 2B. Specifically, the common form of the history of execution of the vision program is applied. With this configuration, the user of the robot control device 1 can use the history of execution in both these devices.

The robot system 100 may further include a program generation device capable of generating a program related to the robot 3. The program generation device may include a receiving unit that receives selection of the built-in image processing device 2A built into the robot control device 1 or the external image processing device 2B provided externally to the robot control device 1, and a generation unit that generates a substantially common vision execution command in the program related to the robot 3 in a case of selecting at least any of the built-in image processing device 2A and the external image processing device 2B. With this configuration, the program generation device is capable of suitably generating the program related to the robot 3. The program generation device includes, e.g., a teaching control board connected to the robot control device and a tablet terminal having a touch panel display. An operation of “receiving selection” includes, for example, input for selecting, by the user, which one of the built-in image processing device 2A or the external image processing device 2B is to be used via a user interface on the teaching control board.

As another embodiment, the robot system 100 may include a robot control device 1 having a first connection terminal connectable to the built-in image processing device 2A and a second connection terminal, which is different from the first connection terminal, connectable to the external image processing device 2B and configured connectable to the built-in image processing device 2A and the external image processing device 2B. The vision execution command in the vision program in the image processing device 2A, 2B and the vision execution command in the robot program are substantially common in a case where the image processing device 2A, 2B is connected to at least any of the first connection terminal and the second connection terminal. With this configuration, the common vision execution command is applied even in a case where the image processing device is connected to any of the first connection terminal connectable to the built-in image processing device 2A and the second connection terminal connectable to the external image processing device 2B, the robot control device 1 can easily switch between the built-in image processing device 2A and the external image processing device 2B.

As still another embodiment, the robot system 100 may include a robot control device 1 having a connection terminal connectable to the external image processing device 2B. The vision execution commands in the vision programs in the built-in image processing device 2A and the external image processing device 2B and the vision execution command in the robot program may be substantially common regardless of whether or not the external image processing device 2B is connected to the connection terminal. With this configuration, for example, even after the external image processing device 2B has been detached, the robot control device 1 can perform the image processing by the built-in image processing device 2A built into the robot control device 1.

The embodiment of the present invention has been described above, but the above-described robot control device 1 can be implemented by hardware, software, or a combination thereof. Moreover, the above-described control method performed by the robot control device 1 can also be implemented by hardware, software, or a combination thereof. Here, implementation by the software means implementation by reading and execution of a program by a computer.

The program can be stored using various types of non-transitory computer readable media and be supplied to the computer. The non-transitory computer readable media include various types of tangible storage media. Examples of the non-transitory computer readable media include magnetic recording media (e.g., a hard disk drive), magnetic optical recording media (e.g., a magnetic optical disk), a CD-read only memory (CD-ROM), a CD-R, a CD-R/W, and semiconductor memories (e.g., a mask ROM, a programmable ROM (PROM), an erasable PROM (EPROM), a flash ROM, and a random access memory (RAM)).

Each of the above-described embodiments is a preferred embodiment of the present invention, but is not intended to limit the scope of the present invention only to each of the above-described embodiments. Various changes can be made without departing from the gist of the present invention.

### EXPLANATION OF REFERENCE NUMERALS

1 Robot Control Device
2A Image Processing Device
2B Image Processing Device
3 Robot
4 Arm
5 Vision Sensor
6 Mount
W Workpiece
100 Robot System

1. A robot control device comprising: at least one image processing device that images a target by a vision sensor mounted on a robot or fixed and installed at a predetermined position,
wherein the at least one image processing device is built into the robot control device or is externally connected to the robot control device, and
a vision execution command in a vision program in the image processing device and a vision execution command in a robot program in the robot control device are substantially common between a built-in image processing device built into the robot control device and an external image processing device externally connected to the robot control device.

2. The robot control device according to claim 1, wherein
the at least one image processing device includes the built-in image processing devices built into the robot control device or the external image processing devices externally connected to the robot control device, and
the vision program is substantially common between the built-in image processing device and the external image processing device.

3. The robot control device according to claim 2, wherein the robot control device transmits an image acquired by the built-in image processing device to the external image processing device, and the external image processing device processes the image.

4. The robot control device according to claim 1, wherein the vision program in the external image processing device is executed on a cloud.

5. The robot control device according to claim 1, wherein a setting screen for setting the vision program is substantially common between the built-in image processing device and the external image processing device.

6. The robot control device according to claim 1, wherein a history of execution of the vision program is substantially common between the built-in image processing device and the external image processing device.

7. A program generation device for generating a program related to a robot, comprising:
a receiving unit that receives selection of a built-in image processing device built into a robot control device or an external image processing device provided externally to the robot control device; and
a generation unit that, in a case in which at least one of the built-in image processing device or the external image processing device is selected, makes a vision execution command in the program substantially common therebetween.

8. A robot control device connectable to at least one image processing device, comprising:
a first connection unit connectable to the at least one image processing device; and
a second connection unit, which is different from the first connection unit, connectable to the at least one image processing device,
wherein a vision execution command in a vision program in the at least one image processing device and a vision execution command in a robot program are substantially common in a case where the image processing device is connected to at least one of the first connection unit or the second connection unit.

9. A robot control device connectable to at least one image processing device, comprising:
a connection unit connectable to the at least one image processing device,
wherein a vision execution command in a vision program in the at least one image processing device and a vision execution command in a robot program are substantially common regardless of whether or not the at least one image processing device is connected to the connection unit.
